(19) United States
(12) Patent Application Publication
(10) Pub. No.: US 2016/0353243 A1
(43) Pub. Date: Dec. 1, 2016

(54) Global Positioning Network System (GPNS)

(71) Applicant: Adam Nicholas Paul, Madison, WI (US)

(72) Inventor: Adam Nicholas Paul, Madison, WI (US)

(21) Appl. No.: 15/165,202

(22) Filed: May 26, 2016

Related U.S. Application Data
(60) Provisional application No. 62/166,465, filed on May 26, 2015.

(51) Int. Cl. H04W 4/02; H04W 64/00; H04W 8/18

(52) U.S. Cl. CPC H04W 4/023; H04W 8/18; H04W 64/006; H04W 84/18

(57) ABSTRACT

The Global Positioning Network System (GPNS) coordinates all available ‘Positioning Location Systems’ into one network system, which then calculates the most optimal positioning combination for each ‘device’ location that is voluntarily or involuntarily connected to the GPNS. Individuals will be able to manage their own devices in the GPNS allowing complete independent control. This will include them in the larger GPNS to help establish more accurate positions for all network system users: Users will be able to create unique networks with other users and businesses which users see as beneficial to their livelihood experience.

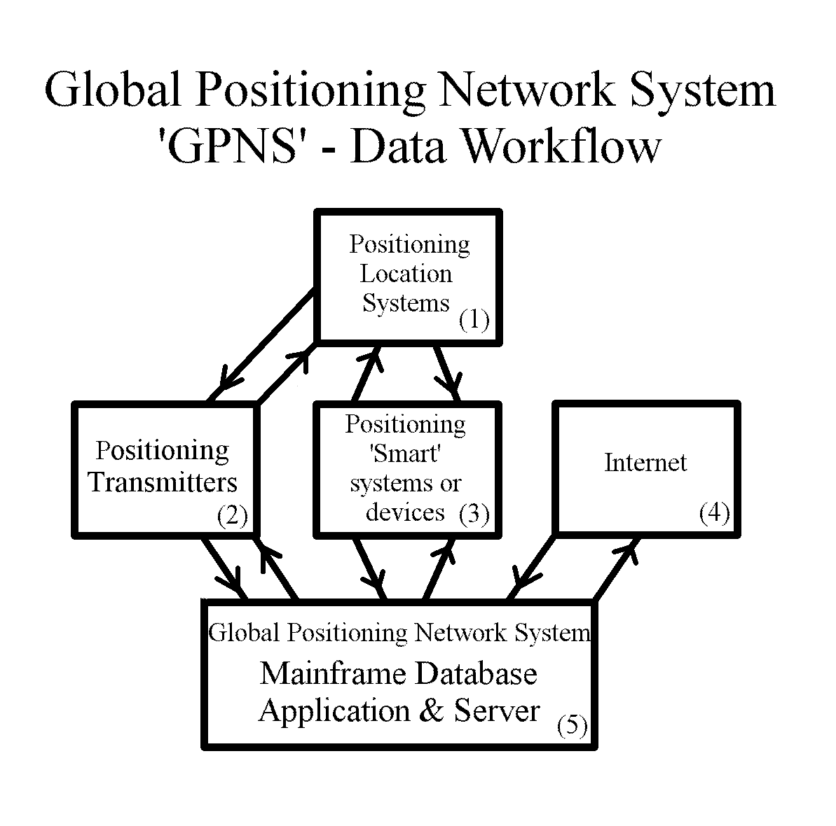

### CROSS-REFERENCE TO RELATED APPLICATIONS

This provisional patent is directly related to the non-provisional patent: 62/166,465 filed May 26, 2015

### STATEMENT REGARDING FEDERALLY SPONSORED RESEARCH AND DEVELOPMENT

There is none. N/A

### REFERENCE TO ‘SEQUENCE LISTING’

There is none. N/A

### BACKGROUND OF THE INVENTION:

The Global Positioning Network (GPNS) coordinates all available ‘Positioning Location Systems’ into one network system, which then calculates the most optimal positioning combination for each ‘Device’ location that is voluntarily or involuntarily connected to the GPNS.

Current location technologies (Global Positioning System (GPS), Assisted GPS, Synthetic GPS, Cell ID, Wi-Fi, Inertial Sensors, Barometer, Ultrasonic (such as RFID (radio-frequency identification), Bluetooth Beacons, and Terrestrial Transmitters) don't integrate each others capabilities for the fastest, most efficient, and accurate outcome in determining ‘device’ locations. Furthermore they don't establish efficient direct user to user communicative contact. The GPNS aims to do this.

### BRIEF DESCRIPTION OF DRAWINGS

The drawings depict the necessary workflow of the GPNS and demonstrate its operational workflow.

### BRIEF SUMMARY OF THE INVENTION

The Global Positioning Network (GPNS) coordinates all available ‘Positioning Location Systems’ into one network system, which then calculates the most optimal positioning combination for each ‘Device’ location that is voluntarily or involuntarily connected to the GPNS.

The more devices connected to the network system, the faster, more efficient, and accurate it becomes.

This will allow individual users to manage their own GPNS and be apart of a larger GPNS.

### DETAILED DESCRIPTION OF THE INVENTION

Individuals will be able to manage their own devices in the GPNS allowing complete independent control. This will include them in the larger GPNS to help establish more accurate positions for all network system users.

Enabling devices to establish precise positions in micro locations such as inside buildings, malls, restaurants, or bars—whilst also allowing devices to been ‘seen’ by other devices of the network system if they choose to share their location—with micro location accuracy by feet, direction and altitude away of each device—giving them the ability to establish contact, both electronically and help them to meet physically.

Users will be able to create their own unique networks with themselves, other users and businesses which they see as beneficial to their livelihood. All data will be kept secure in the GPNS and only shared when given permission by each user.

1) The Global Positioning Network System (GPNS):
The GPNS is the ultimate positioning system which integrates all available positioning system capabilities into one GPNS to establish the most accurate position and communication capabilities for all ‘devices’ connected to the network system. This process is demonstrated in the drawings of the invention.
The figure is defined by:
(1) Positioning Location Systems—This includes all locating systems which have the ability to locate a position of a device or devices around it. These systems and devices include but are not limited to:
Global Positioning System (GPS), Assisted GPS, Synthetic GPS, Cell ID, Wi-Fi, Inertial Sensors, Barometer, Ultrasonic (such as RFID (radio-frequency identification), Bluetooth Beacons, and Terrestrial Transmitters.
(2) Positioning Transmitters—This includes all transmitting only location systems and devices, which are programed to establish their position by using one of the Location Systems (1) which then connect and share their location data with the GPNS (5).
(3) Positioning ‘Smart’ Systems or Devices—This includes all transmitting and receiving location systems and devices that establish their position by using one of the Location Systems (1), which then voluntarily or involuntarily connect and share their location data with the GPNS (5).
(4) Internet—Allows all internet capable users access and manage to their GPNS (5) account.
(5) Global Position Network System Mainframe Database Application and Server (GPNS)—Collects, analyzes, organizes and redistributes the data from and to the transmitting location systems and devices (1,2,3,4) to calculate the most optimal positioning combination of each device for functionality and accuracy.
